(19) United States
(12) Patent Application Publication
(10) Pub. No.: US 2023/0170694 A1
(43) Pub. Date: Jun. 1, 2023

(54) SYSTEM AND METHOD FOR EVALUATING RELIABILITY OF AN ELECTRICAL NETWORK

(71) Applicant: Prabuddha Banerjee, Whitman, MA (US)

(72) Inventor: Prabuddha Banerjee, Whitman, MA (US)

(21) Appl. No.: 17/536,484

(22) Filed: Nov. 29, 2021

(51) Int. Cl. H02J 3/00; G06Q 10/06

(52) U.S. Cl. CPC H02J 3/00; G06Q 10/0635; H02J 2203/20

(57) ABSTRACT

The present invention provides for evaluating reliability of electrical network or sub-section of network based on multiple network-variables. In operation, each source node connected to selected end-node and switch status of connected source node(s) is determined based on node information associated with electrical network. Further, network topology from each switched ON source node(s) up to selected end-node is determined. Furthermore, power supply availability of each switched ON source node(s) is determined based on determined network topology and availability status of each connectivity-node downstream of corresponding switched ON source node(s) up to selected end-node. Finally, network reliability up to selected end-node is computed based on evaluated switched ON source node(s) available for power supply and reliability of evaluated switched ON source node(s), determined network topology from each switched ON source node(s) up to selected end-node, and reliability of each connectivity-node downstream of evaluated switched ON source node(s) up to selected end-node.

### FIELD OF THE INVENTION

The present invention relates generally to the field of power transmission and distribution. More particularly, the present invention relates to a system and a method for evaluating reliability of an electrical network, whereby failure of at least one or more sections of the network can be managed and power supply continuity can be improved prior to actual network failure.

### BACKGROUND OF THE INVENTION

In general, electricity is generated at power plants by electricity producers, and thereafter it is transmitted and distributed through a complex interconnected network of electrical substations, transformers, circuit breakers, reclosers, power lines and other like components to the consumers. The entire network of power plants, electrical substations, transformers, circuit breakers, reclosers, and power lines along with several other components is referred to as electrical grid. A typical electrical grid comprises power plants, and power transmission and/or distribution network including a plurality of miles of high-voltage power lines and plurality of miles of low-voltage power lines with distribution transformers that connect plurality of power plants to plurality of electricity consumers all across an area.

The power transmission and/or distribution network associated with any electrical grid may be segregated into smaller interconnected sub-sections for enhanced reliability, coordination and commercial purposes. The entire power transmission and/or distribution network and/or network sub-sections comprise one or more substations, transmission lines, and distribution lines connecting the power plants to the load(consumers). Each of the substations further comprise one or more components such as, but not limited to, circuit breakers, switches, tie breakers, step-up transformers, step-down transformers, and the like. Each of the aforementioned individual components of the power transmission and/or distribution network and/or sub-sections are generally configured to handle one function. Therefore, a fault in any of the components downstream of any source power supply, such as a transformer or a substation or a recloser, in the network will have a cascading effect on the power supply to the adjacent components or entire sub-section in the network unless an alternative power supply path is also available.

At present, majority of the utilities monitor outages in an electric network, in particular in the power transmission and/or distribution network, based on an energization status of the network. However, monitoring of outages in a network based on energization status can identify an outage once the network has been de-energized due to a fault or downtime of any of the individual components or the power lines. In particular, once any of the individual components is down, the utilities get notified after the cascading effect of the faulty component causes failure of the network or a large grid. Further, monitoring of network based on energization status leads to high outage and restoration time, further imposing security risks around the area where the grid is deployed. Furthermore, deteriorating the regulatory KPIs such as, SAIDI (System Average Interruption Duration Index), SAIFI (System Average Interruption Frequency Index) etc. that are used to measure the efficiency of a utility. Yet further, costing a lot to consumer industries on the account of outage.

In accordance with another existing technique, the utilities determine potential of failure of an electrical network by analyzing each component in the electrical network based on historical customer interruption data. Further, the utilities calculate KPIs such as SAIDI and SAIFI, and grade the best performing and worst performing components based on the calculated KPIs. However, the afore-described technique does not focus on the real reason behind the failure, neither does it takes into account the present condition of the network components and predict chances of failure in near future.

In order to overcome the abovementioned drawbacks, some of the utilities have explored the idea of determining reliability of similar components to predict faults in the individual components and accordingly manage power supply continuity in the network. However, component reliability only provides a measure of probability with which a component is expected to be available in the power network without downtime for a predefined duration of time. Further, the component reliability cannot predict the number of sub-sections and customers that would be affected by probable failure of a single component, because one component may energize many sub-sections, and one sub-section may get power from many components. As a result, managing power supply continuity and preventing faults in the network further requires determining network reliability in addition to individual component reliability, as network reliability provides a measure of probability with which the network or a sub-section of network will be available without downtime. The determined network reliability can be readily used as a parameter to at least maintain or replace components and power lines in the network, deploy alternate power supply for the sub sections in the network, and re-route power supply prior to an actual outage. However, computing network reliability is a complex task, and is dependent on multiple variables such as, but not limited to, number of available power supply sources, reliability and status of individual components connecting a power supply source to a desired node, and topology of the network i.e. the path of interconnection between the individual components from the source to the desired node. Further, the network reliability changes with change in one or more of the multiple variables, as a result, the network reliability needs re-evaluation every time any of the multiple variables changes.

In light of the above drawbacks, there is a need for a system and a method that can evaluate reliability of an electrical network. In particular, there is a need for a system and a method that evaluates reliability of an electrical network or sub-section of the network based on multiple network-variables. Further, there is need for a system and a method that can automatically analyze complex data to evaluate reliability of an electrical network in real-time as well as for a future time duration. Furthermore, there is a need for a system and a method, which can evaluate reliability of individual components, based on multiple factors, such as, age, maintenance schedule, historic performance, weather conditions etc. and can accordingly extend the individual reliability of components to network reliability. Yet further, there is a need for a system and a method that can evaluate network reliability by considering the impact of network reconfiguration. Yet further, there is need for a system and a method that can generate notification alarms in case of deteriorating network reliability. Yet further, there is a need for a system and a method, which is economical, relatively accurate and facilitates efficient utilization of power. Yet further, there is a need for a system and a method which is easy to implement and can be integrated with any of the existing electrical networks.

### SUMMARY OF THE INVENTION

In accordance with various embodiments of the present invention, a method for evaluating network reliability up to an end-node in an electrical network is provided. The method is implemented by a processor executing program instructions stored in a memory. The method comprising determining each source node of the electrical network connected with the end-node and switch status of each of the determined source node(s) based on a node information associated with the electrical network using data analysis. The method further comprises determining network topology from each switched ON source node(s) up to the end-node, where each connectivity-node downstream of the switched ON source node(s) up to the end-node, and arrangement pattern and line-sections connecting said switched ON source node(s), the end-node and said each connectivity-node downstream of the switched ON source node(s) up to the end-node are determined. Further, the method comprises evaluating power supply availability of each switched ON source node(s) based on at least one of: the determined network topology, and an availability status of said each connectivity-node downstream of the corresponding switched ON source node(s) up to the end-node. Furthermore, the method comprises computing network reliability up to the end-node based on at least one of: the evaluated switched ON source node(s) available for power supply and reliability of said evaluated switched ON source node(s), determined network topology from each evaluated switched ON source node(s) up to the end-node, and reliability of each connectivity-node downstream of the evaluated switched ON source node(s) up to the end-node.

In accordance with various embodiments of the present invention, a system for evaluating network reliability up to an end-node in an electrical network is provided. The system comprises a memory storing program instructions, a processor configured to execute program instructions stored in the memory, and a reliability computation engine executed by the processor, and configured to determine each source node of the electrical network connected with the end-node and switch status of each of the determined source node(s) based on a node information associated with the electrical network using data analysis. Further, the system is configured to determine network topology from each switched ON source node(s) up to the end-node, wherein each connectivity-node downstream of the switched ON source node(s) up to the end-node, and arrangement pattern and line-sections connecting said switched ON source node(s), the end-node and said each connectivity-node downstream of the switched ON source node(s) up to the end-node are determined. Furthermore, the system is configured to evaluate power supply availability of each switched ON source node(s) based on at least one of: the determined network topology, and an availability status of said each connectivity-node downstream of the corresponding switched ON source node(s) up to the end-node. Yet further, the system is configured to compute network reliability up to the end-node based on at least one of: the evaluated switched ON source node(s) available for power supply and reliability of said evaluated switched ON source node(s), determined network topology from each evaluated switched ON source node(s) up to the end-node, and reliability of each connectivity-node downstream of the evaluated switched ON source node(s) up to the end-node.

In accordance with various embodiments of the present invention, a computer program product is provided. The computer program product comprises a non-transitory computer-readable medium having computer-readable program code stored thereon, the computer-readable program code comprising instructions that, when executed by a processor, cause the processor to determine each source node of the electrical network connected with the end-node and switch status of each of the determined source node(s) based on a node information associated with the electrical network using data analysis. Further, network topology from each switched ON source node(s) up to the end-node is determined, wherein each connectivity-node downstream of the switched ON source node(s) up to the end-node, and arrangement pattern and line-sections connecting said switched ON source node(s), the end-node and said each connectivity-node downstream of the switched ON source node(s) up to the end-node are determined. Furthermore, power supply availability of each switched ON source node(s) is evaluated based on at least one of: the determined network topology, and an availability status of said each connectivity-node downstream of the corresponding switched ON source node(s) up to the end-node. Yet further, network reliability up to the end-node is computed based on at least one of: the evaluated switched ON source node(s) available for power supply and reliability of said evaluated switched ON source node(s), determined network topology from each evaluated switched ON source node(s) up to the end-node, and reliability of each connectivity-node downstream of the evaluated switched ON source node(s) up to the end-node.

### BRIEF DESCRIPTION OF THE ACCOMPANYING DRAWINGS

The present invention is described by way of embodiments illustrated in the accompanying drawings wherein:

FIG. 1 is a block diagram of an environment including a system for evaluating reliability of an electrical network, in accordance with various embodiments of the present invention;

FIG. 1A illustrates a detailed block diagram of a system for evaluating reliability of an electrical network, in accordance with various embodiments of the present invention;

FIG. 1B illustrates a linear network topology with a single source node, in accordance with various embodiments of the present invention;

FIG. 1C illustrates a linear network topology with double sources, in accordance with various embodiments of the present invention;

FIG. 1C′ illustrates a linear network topology with double sources, in accordance with various embodiments of the present invention;

FIG. 1D illustrates a linear network topology with a branch off, in accordance with various embodiments of the present invention;

FIG. 1E illustrates a loop network topology with a single source node, in accordance with various embodiments of the present invention;

FIG. 1F illustrates a combination of loop and linear network topology, in accordance with various embodiments of the present invention;

FIG. 1G illustrates a combination of loop and branch off network topology, in accordance with various embodiments of the present invention;

FIG. 2 is a flowchart illustrating a method for evaluating reliability of an electrical network, in accordance with various embodiments of the present invention; and

FIG. 3 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention. The term “electrical network” as used in the specification refers to an interconnected network of power generation systems, power transmission and/or distribution systems as a whole as well in sections. The term “network reliability” as used in the specification refers to a measure of probability with which the network or a sub-section of network will be available for power supply without downtime. The term “downstream” as used in conjunction with source node in the specification implies that the power flow of the downstream component is in the direction of power flow of the source node.

The present invention discloses a system and a method for evaluating reliability of an electrical network. In particular, the present invention discloses a system and a method that can evaluate reliability of an electrical network or a sub-section of the network up to one or more end-nodes based on multiple network-variables. In operation, the present invention provides for building a database comprising information associated with each node of the selected electrical network including, but not limited to, power plants, Distributed Energy Resources (DERs), substations, transformers, transmission lines, distribution lines, and consumers along with their interconnection or topology. The database further comprises information related to circuit breakers and switches associated with each node, information associated with each sub-section and nodes of the network; and historical outage data associated with each node. The present invention, further provides for generating a network-connectivity model based on the network-database, where the network-connectivity model is representative of a graphical representation of electrical networks over an area. Further, the present invention provides for determining each source node connected to a selected end-node and switch status of the determined source node(s) based on node information associated with the electrical network using data analysis, where the node information is retrieved from network-database. The source node is representative of any node from which power supply commences for transmission and/or distribution, and the end-node is representative of any node, which is to receive power supply for consumption. Furthermore, the present invention provides for determining network topology from each switched ON source node(s) up to the selected end-node, where each connectivity-node, arrangement pattern and line-sections connecting the respective connectivity-nodes downstream of the switched ON source node(s) up to the selected end-node are determined. The connectivity-node is any node which transmits and/or distributes power from source node to the end-node. Yet further, the present invention provides for evaluating power supply availability of each switched ON source node(s) based on the determined network topology, and availability status of each connectivity-node downstream of the corresponding switched ON source node(s) up to the selected end-node. Each connectivity-node with switch in closed position is considered to have available status. Yet further, the individual reliability of each connectivity-node downstream of corresponding evaluated switched ON source node(s) up to the selected end-node is computed based on one or more reliability-parameters including, but not, limited to age, maintenance schedule, weather conditions, historical outage data, and real-time condition variables. Finally, the present invention provides for computing network reliability up to the selected end-node based on at least one of: the evaluated switched ON source node(s) available for power supply and reliability of evaluated switched ON source node(s), determined network topology from each switched ON source node(s) up to the selected end-node, and reliability of each connectivity-node downstream of said evaluated switched ON source node(s) up to the selected end-node using one or more predefined set of rules. The one or more predefined set rules are selected based on the determined network topology and switched ON source node(s) available for power supply.

The present invention would now be discussed in context of embodiments as illustrated in the accompanying drawings.

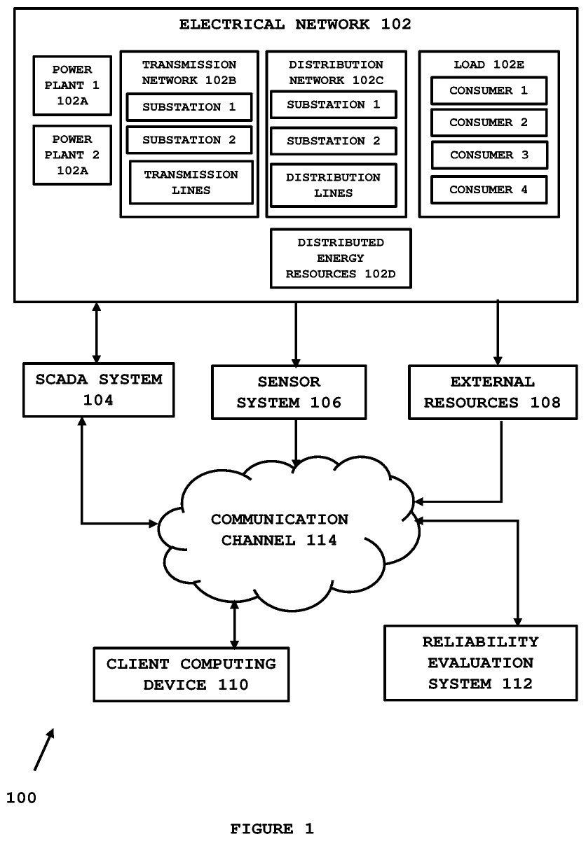

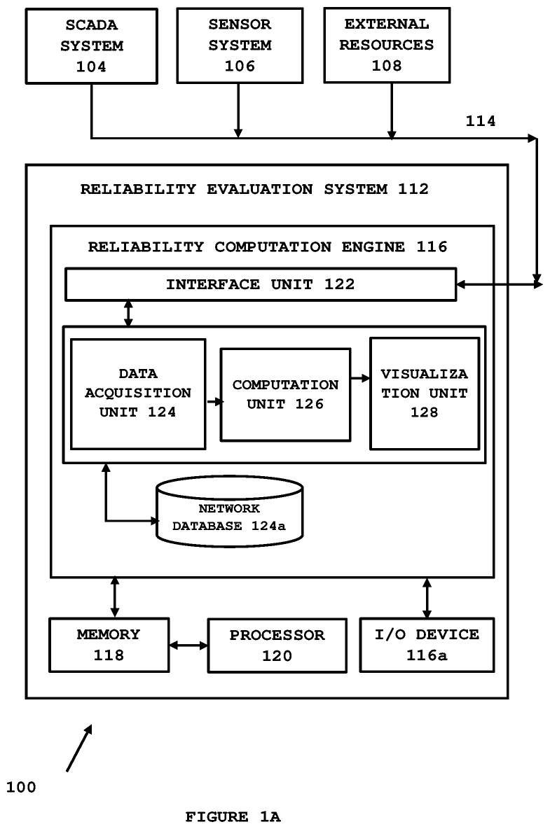

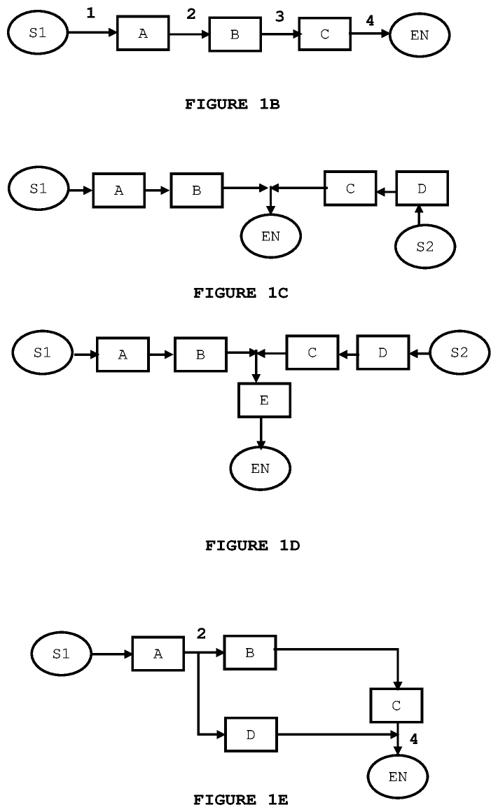

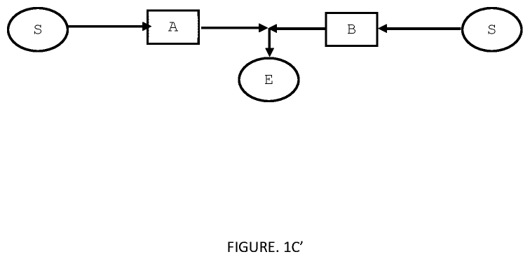

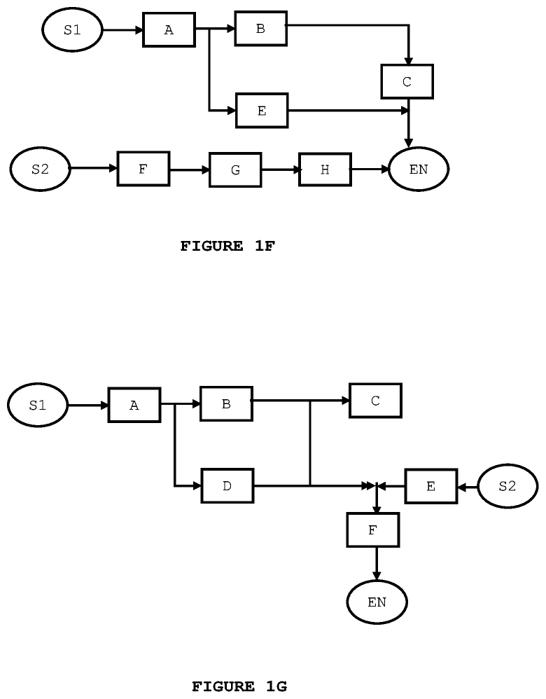

Referring to FIG. 1 a block diagram of an environment including a system for evaluating reliability of an electrical network in accordance with various embodiments of the present invention is illustrated. In an embodiment of the present invention the environment 100 includes an electrical network 102, a SCADA system 104, a sensor system 106, external resources 108, a client-computing device 110, and a system for evaluating reliability of an electrical network, herein after referred to as reliability evaluation system 112.

In accordance with various embodiments of the present invention, the electrical network 102 may be any network or a sub-section of the network, which is configured to at least perform one of: generation of electricity, transmission of electricity, and distribution of electricity to the consumers. In accordance with an embodiment of the present invention, as shown in FIG. 1, the electrical network comprises one or more power plants 102A, one or more transmission network 102B, one or more distribution network 102C, one or more distributed energy resources 102D and load 102E. In accordance with an embodiment of the present invention, transmission and/or distribution network and/or network sub-sections comprise one or more substations, transmission lines, and distribution lines connecting the power plants 102A to the load 102E(consumers) spread over an area. Each of the substation further comprises one or more components such as, but not limited to, circuit breakers, switches, tie breakers, step-up transformers, step-down transformers, and the like.

In operation, the electrical network 102 defined herein as a network having components for power generation, transmission and/or distribution of electrical power may be considered in entirety or any portion of the entire electrical network 102 may be also considered as a network. For instance, the electrical network may be an entire power transmission and distribution system, a substation, a plurality of substations, a section of a transmission line, a section of a distribution line, and the like. In accordance with various embodiment of the present invention, each component of the network is referred to as a node. The node of a network may be categorized into a source node, an end-node and a connectivity-node.

In an embodiment of the present invention, the source node is representative of any node from which power supply commences for transmission and/or distribution, such as a power plant, a substation and associated components. The end-node is representative of any node, which is to receive power supply for consumption and/or further transmission or distribution, such as, a consumer, relays on transmission lines, relays on distribution lines and transformers. In an embodiment of the present invention, the connectivity-node is any node which transmits and/or distributes power from source node to the end-node, such as, relays on transmission lines, relays on distribution lines and transformers. For example, if the network reliability is to be computed up to a selected distribution substation, then the distribution substation is the end-node, one or more power plants supplying power to the distribution substation are the source nodes, and the transmission components connecting the power plants to the distribution substations are the connectivity-nodes. In another example, if the network reliability is to be computed up to a consumer, then the consumer is the end-node; the one or more substations and/or the DERs supplying power to the consumer are the source nodes; and the distribution lines, distribution relays and other components facilitating power supply from the source node to the end-node are the connectivity-nodes.

In an embodiment of the present invention, the Supervisory Control and Data Acquisition (SCADA) System 104 is a monitoring tool configured to control various components of the electrical network 102 and record data, even from remote locations. In accordance with various embodiments of the present invention, the SCADA system 104 interfaces with the electrical network 102. In an embodiment of the present invention, the SCADA system 104 is configured to monitor components of the electrical network 102 in real-time and provide switch status i.e. open/close status of any component. The SCADA system 102 is further configured to provide real-time operational parameters like oil temperature, winding temperature, load etc. of any component in the electrical network 102. In accordance with various embodiments of the present invention, the SCADA system 104 interfaces with the reliability evaluation system 112 via the communication channel 114. Examples of the communication channel 114 may include, but are not limited to, an interface such as a software interface, a physical transmission medium such as a wire, or a logical connection over a multiplexed medium such as a radio channel in telecommunications and computer networking. Examples of radio channel in telecommunications and computer networking may include, but are not limited to, a Local Area Network (LAN), a Metropolitan Area Network (MAN), and a Wide Area Network (WAN).

In an embodiment of the present invention, the sensor system 106 comprises a plurality of sensing devices (not shown) such as, but not limited to, optical sensors, location sensors, temperature sensors, humidity sensors, alarm sensors, load sensors, quality sensors and the like. In accordance with various embodiments of the present invention, the sensor system 106 interfaces with the electrical network 102 to retrieve data, such as, but not limited to, load profile, node location, faults, quality, weather conditions, temperature and any other data associated with various components of the electrical network in real time. In accordance with various embodiments of the present invention, the sensor system 106 interfaces with the reliability evaluation system 112 to provide the retrieved data via the communication channel 114. In an embodiment of the present invention, the sensor system 106 is configured with a telemetry device (not shown) to provide the retrieved data to the reliability evaluation system 112. In another embodiment of the present invention, the sensor system 106 is integrated with the SCADA system 104. Further, the sensor system 106 is configured to transmit retrieved data to the reliability and evaluation system 112 through the SCADA system 104.

In accordance with various embodiments of the present invention, the external resources 108 include third party systems, such as databases, computing resources, consumer management tools, electrical component inspection and maintenance tools, vegetation management tools, component switching tools, power flow sensing tools, weather forecast tools etc. Examples of third party systems, include, but are not limited to, Distributed Control System (DCS), Programmable Logic Controller (PLC), Historian, Asset Performance Monitoring tool (APM), Enterprise Asset Management (EAM) tool, Advanced Metering Infrastructure (AMI) tool etc. In an embodiment of the present invention, the third party systems, such as DSC may be used for capturing real-time process data of components associated with the power plant 102A. Further, the PLC may be used to capture and control process parameters. Historian may be used for compressing time series data for long duration storage of data. APM may be used for storing process parameters that can assist in computing the reliability of electrical components. EAM may be used for managing all asset information including name, capacity, age, maintenance records, process parameters etc. AMI may be used for retrieving near real-time electrical status of source nodes. In an embodiment of the present invention, the third party databases comprise historical data associated with each component (also referred to as node) of the network. In an embodiment of the present invention, the weather forecast tools are configured to assess real time weather conditions and future weather conditions. In an embodiment of the present invention, the external resources 108 interface with the reliability evaluation system 112 via the communication channel 114 to provide at least the weather forecast and historical data associated with each component of the electrical network 102. In an embodiment of the present invention, the historical data includes component type, age, failure history, and maintenance history.

In accordance with various embodiments of the present invention, the client-computing device 110 may be a general purpose computer such as a desktop, a laptop, a smartphone and a tablet; a super computer; a microcomputer or any device capable of executing instructions, connecting to a network and sending/receiving data. In an embodiment of the present invention, the client-computing device 110 accesses the reliability evaluation system 112 via the communication channel 114 to compute reliability of an electrical network. In an embodiment of the present invention, a user module of the reliability evaluation system 112 may be installed onto the client-computing device 110 to access the reliability evaluation system 112 via the communication channel 114.

In accordance with various embodiments of the present invention, the reliability evaluation system 112 may be a software executable by a computing device, or a combination of software and a hardware. In an embodiment of the present invention as shown in FIG. 1, the reliability evaluation system 112 is a combination of a software and a hardware. In an embodiment of the present invention, the reliability evaluation system 112 may be implemented as a client-server architecture, wherein the client-computing device 110 accesses a server hosting the reliability evaluation system 112 over the communication channel 114. In an exemplary embodiment of the present invention, the functionalities of the reliability evaluation system 112 are delivered as Software as a Service (SAAS) to one or more client-computing devices 110. In another embodiment of the present invention, the reliability evaluation system 112 may be implemented in a cloud computing architecture in which data, applications, services, and other resources are stored and delivered through shared data-centers. In an exemplary embodiment of the present invention, the reliability evaluation system 112 is a remote resource implemented over the cloud and accessible for shared usage in a distributed computing architecture by various client-computing devices 110. In an exemplary embodiment of the present invention, the reliability evaluation system 112 may be accessed via an IP address/domain name. In another exemplary embodiment of the present invention, the reliability evaluation system 112 may be accessed via a user module of the reliability evaluation system 112 executable on the client-computing device 110.

In another embodiment of the present invention, the reliability evaluation system 112 is a software locally installable and executable by the client-computing device 110. In an embodiment of the present invention, the client-computing device 110 is configured with a Graphical User Interface (GUI) of the reliability evaluation system 112 to at least select an electrical network, upload data associated with the electrical network, select source node and end-nodes for reliability calculation, receive network reliability, and receive graphic visualization of the electrical network along with network reliability among other things. In an exemplary embodiment of the present invention, the reliability evaluation system 112 is implemented using python scripts and QGIS visualization tool. In an exemplary embodiment of the present invention, the python library for python scripts is NetworkX.

In accordance with various embodiments of the present invention, the reliability evaluation system 112 is configured to interface with the SCADA system 104, the sensor system 106 and the external resources 108 further interfacing with the electrical network 102. In an embodiment of the present invention, the reliability evaluation system 112 is configured to interface with the SCADA system 104 to retrieve switch status of the components(nodes) of the electrical network 102. In an embodiment of the present invention, the reliability evaluation system 112 is configured to interface with sensor system 106 to receive at least the load profile, node location, faults, quality, weather conditions, temperature and any other data associated with various components of the electrical network 102 in real time.

In an embodiment of the present invention, the reliability evaluation system 112 is configured to interface with the external resources 108 to receive at least the weather forecast, consumer information associated with the electrical network 102, vegetation data, power flow data, and historical data associated with each node(component) of the electrical network 102. In an embodiment of the present invention, the consumer information, includes, but is not limited to, customer name, location, load capacity, etc. In an embodiment of the present invention, the historical data includes component type, age, failure history, and maintenance history. In an embodiment of the present invention, the vegetation data includes data associated with trimming of tree and growth rate of trees near or around any of the components of the electrical network.

Referring to FIG. 1A a detailed block diagram of a system for evaluating reliability of an electrical network, is illustrated. In accordance with an embodiment of the present invention, the reliability evaluation system 112 comprises a reliability computation engine 116, an Input/output (I/O) device 116a, a memory 118, and a processor 120. The reliability computation engine 114 is operated via the processor 120 specifically programmed to execute instructions stored in the memory 118 for executing functionalities of the reliability computation engine 116 in accordance with various embodiments of the present invention. In accordance with various embodiments of the present invention, the memory 118 may be a Random Access Memory (RAM), a Read Only Memory (ROM), hard drive disk (HDD), Solid-state drive (SDD) or any other memory capable of storing data and instructions.

In accordance with various embodiments of the present invention, the reliability computation engine 114 is a self-learning engine configured to retrieve complex data, analyze retrieved complex data to build a network-database, generate a network-model of the electrical network with all nodes based on the database, evaluate source nodes and downstream connectivity-nodes up to a selected end-node based on the network-database, evaluate network topology, compute reliability of individual connectivity-nodes, compute reliability of the network based on the individual reliability and network topology.

In accordance with various embodiments of the present invention, the reliability computation engine 116 comprises an interface unit 122, a data acquisition unit 124, a network-database 124a, a computation unit 126, and a visualization unit 126. The various units of the reliability computation engine 116 are operated via the processor 120 specifically programmed to execute instructions stored in the memory 118 for executing respective functionalities of the multiple units (122, 124 124a, 126, and 128) in accordance with various embodiments of the present invention.

In accordance with various embodiments of the present invention, the interface unit 122 is configured to facilitate communication with the SCADA system 104, the sensor system 106, the external resources 108, and the client-computing device (110 of FIG. 1). In an embodiment of the present invention, the interface unit 122 is configured to provide communication with the I/O device 116a associated with the reliability computation engine 116 for updating system configurations, receiving inputs from a user and outputting results.

In an embodiment of the present invention, the interface unit 122 is configured with at least one of: a web gateway, a mobile gateway, a Graphical User Interface (GUI), an integration interface, and an administration interface to facilitate interfacing with the SCADA system 104, the sensor system 106, the external resources 108, and the client-computing device (110 of FIG. 1). In an exemplary embodiment of the present invention, the integration interface is configured with one or more APIs such as REST and SOAP APIs to facilitate smooth interfacing and/or integration with the SCADA system 104, the sensor system 106, the external resources 108, and the client-computing device (110 of FIG. 1). In an exemplary embodiment of the present invention, the administration interface provides communication with the Input/output device 116a and/or client-computing device 110 for receiving administration configuration from system admins.

In an embodiment of the present invention, the GUI is accessible on the client-computing device 110 and/or the I/O device 116a to facilitate user interaction. In an exemplary embodiment of the present invention, the Graphical User Interface (GUI) allows a user to at least create login credentials, sign-in using the login credentials, input data, select an electrical network, upload data associated with the electrical network for building a network-database, reconfigure network, select source nodes and end-nodes for reliability calculation, receive network reliability, and receive graphic visualization of the electrical network along with reliability among other things. In an embodiment of the present invention, the graphical user interface (GUI) associated with the interface unit 122 may be accessed from the client-computing device 110 through a web gateway. In another embodiment of the present invention, the GUI associated with the interface unit 122 may be accessed by the mobile gateway using a user module installable on the client-computing device 110. In an embodiment of the invention, where the reliability evaluation system 112 is a software installable and executable by the client-computing device 110, the GUI along with other units are locally accessible on the client-computing device 110.

In accordance with various embodiments of the present invention, the data acquisition unit 124 is configured to retrieve data from SCADA system 104, sensor system 106 and external resources 108 via the interface unit 122. In an embodiment of the present invention, the data acquisition unit 124 is configured to retrieve switch status of each node of the electrical network 102 from the SCADA system 104. In an embodiment of the present invention, the data acquisition unit 124 is configured to retrieve real-time condition-variables of each node of the electrical network 102 from the sensor system 106. The real-time condition-variables include, but are not limited to, node location, load profile, faults, quality, weather conditions near individual nodes, oil or winding temperature, dissolve gas analysis result for one or more nodes (in particular for transformers) and any other data associated with various nodes(components) of the electrical network 102. In an embodiment of the present invention, the data acquisition unit 124 is configured to interface with the external resources 108 to receive at least the weather forecast, consumer information associated with the electrical network 102, vegetation data, power flow data, and historical data associated with each node(component) of the electrical network 102. As already described earlier in the specification, the consumer information, includes, but is not limited to, customer name, location, load capacity, etc. The historical data includes component type, age, failure history, and maintenance history. The vegetation data includes data associated with trimming of tree and growth rate of trees near or around any of the components of the electrical network which can adversely affect the network and/or network sub-section.

In an embodiment of the present invention, the data acquisition unit 124 is further configured to build the network-database 124a based on the retrieved data using one or more data compression techniques. In operation, the data acquisition unit 124 builds a network-database 124a comprising information associated with each node of the electrical network including, but not limited to, power plants, Distributed Energy Resources (DERs), substations, transformers, transmission lines, distribution lines, and consumers along with their interconnection or topology. The network-database further comprises information related to circuit breakers and switches associated with each node, information associated with each sub-section and nodes of the network. In an embodiment of the present invention, the information associated with each node, herein after referred to as node information includes, but is not limited to, location, type, function, switch status, load capacity, quality, age, fault history, maintenance schedule and vegetation data of each node, interconnection with neighbouring nodes, and line-section connecting the neighbouring nodes. In an embodiment of the present invention, the network-database 124 is updated in real-time based on changes in the retrieved data.

In an embodiment of the present invention, the data acquisition unit 124 is configured to generate a network-connectivity model based on the network-database 124a using data processing and analytics. The network-connectivity model is representative of graphical representation of the electrical network 102 spreading over an area, further illustrating each sub-section of the electrical network, each node in the sub-section and its connection with neighboring nodes via a line-section.

In an embodiment of the present invention, the computation unit 126 is configured to receive the network-connectivity model, node information and information associated with each sub-section of the electrical network from the data acquisition unit 124. In an embodiment of the present invention, the computation unit 126 is configured to compute network reliability up to a selected end-node of the electrical network 102. In operation, the computation unit 126 is configured to determine each of the source node(s) connected to the selected end-node and switch status of the source node(s) connected to the end-node. As already described earlier in the specification, the source node is representative of any node from which power supply commences for transmission and/or distribution. In an exemplary embodiment of the present invention, the source node is a distribution substation and/or a distributed energy resource (DER). Further, the end-node is representative of any node, which is to receive power supply for consumption and/or further transmission or distribution. In an exemplary embodiment of the present invention, the end-node is a consumer. In an embodiment of the present invention, the number of source node(s) and their switch status is determined based on node information associated with the electrical network 102 maintained in the network-database 124a using data analysis. In an exemplary embodiment of the present invention, the source node(s) having power flow towards the selected end-node via one or more power supply paths is considered as a source node connected to the selected end-node. In accordance with various embodiments of the present invention, the source node(s) may be connected directly or indirectly via other nodes with the selected end-node. In an embodiment of the present invention, a source node with switch set to close position is considered switched ON source node, and a source node with switch set to open position is considered switched OFF source node. In an embodiment of the present invention, a DER source node with switch status closed and non-islanding is considered switched ON source node. In an embodiment of the present invention, the power supply effect of DER is limited to the islanded section(s) only, considering DER source node can only power within corresponding islanding limits during an emergency.

Further, the network topology, also referred to as power supply topology, from each switched ON source node(s) up to the selected end-node is determined. In an embodiment of the present invention, determining network topology from each of the switched ON source node(s) comprises determining each connectivity-node downstream of the switched ON source node(s) up to the selected end-node, and determining arrangement pattern and line-sections connecting the switched ON source node(s), the selected end-node and each connectivity-node with the neighboring connectivity-node(s), selected end-node and corresponding source node(s). In an embodiment of the present invention, the connectivity-node is any node which transmits/or distributes power from the source node to the end-node. In an embodiment of the present invention, the line-sections may be transmission or distribution lines. In an exemplary embodiment of the present invention, the connectivity-nodes may include, but are not limited to, distribution components, and the line-sections may include distribution lines. In an embodiment of the present invention, a connectivity-node may be directly connected to the source node and/or the end-node via the line-sections. Further, a connectivity-node may be indirectly connected to the source node and/or the end-node via the other connectivity-nodes there between via the line sections. In an embodiment of the present invention, each node, including the source node, the connectivity-node, and the end-node has three phases A, B and C. Further, each line-section has three phases A, B and C. In accordance with various embodiments of the present invention, a line section with phase A, B or C connects the same phase of one or more nodes on both ends. In operation, the computation unit 126, is configured to determine the network topology from each switched ON source node(s) up to the selected end-node based on the information stored in the network-database 124a using data analysis. In accordance with various embodiments of the present invention, the network topology from the source node(s) up to the selected end-node can be at least one of: a straight line, a loop and a branch off.

In embodiment of the present invention, the computation unit 126 is further configured to evaluate power supply availability of each switched ON source node(s) based on at least one of: the determined network topology, and availability status of each connectivity-node downstream of the corresponding switched ON source node(s) up to the selected end-node. In an embodiment of the present invention, each connectivity-node with switch in closed position is considered as available connectivity-node. Each connectivity-node with switch in open position, or connectivity-node on hot standby, down due to fault or maintenance purposes is considered unavailable. In an embodiment of the present invention, the availability of each connectivity-node downstream of the corresponding switched ON source node(s) up to the selected end-node via a single power supply path is indicative that the switched ON source node(s) is available for power supply. Referring to FIG. 1B, a linear network topology is shown. As shown in FIG. 1B, a single source node S1 is connected to supply power to the end-node (EN) via the connectivity-nodes A, B and C through a linear path. If any of the connectivity-nodes before the end-node malfunctions or is switched OFF, then the power supply to end-node is disconnected, and the source node S1 is considered unavailable for power supply.

Referring to FIG. 1C, an example of linear topology with two source nodes supplying power to the end-node is illustrated. In case one source node fails, the other node will supply power to the end-node. Referring to FIG. 1D, a linear network topology with a branch off is illustrated. Referring to FIG. 1E, a loop network topology from a single source node is illustrated. Referring to FIG. 1F, a combination of loop and linear network topologies is illustrated. As shown in the figure, two sources S1 and S2 are powering the end-node.

Referring to FIG. 1G, a combination of loop and branch off network topology is illustrated. As shown in the figure there are two sources S1 and S2 supplying power to the end-node. Source node S1 is supplying power through two paths. First path comprises connectivity-nodes A, D and F, and the second path comprises connectivity-nodes A, B and F. In case connectivity-node A malfunctions, then power supply from source S1 stops, however if B malfunctions, power supply from S1 continues via A, D, and F. Similarly, if D malfunctions, then power supply from S1 continues from A, B and F. In case node A and/or both B and D malfunctions, then power supply from source S2 continues, and S2 is considered available for power supply.

In accordance with various embodiments of the present invention, the computation unit 126 is further configured to compute individual reliability of the evaluated switched ON source node(s) and each connectivity-node downstream of corresponding available switched ON source node(s) up to the selected end-node. In an embodiment of the present invention, the individual reliability of connectivity-node(s) that are switched ON is computed. In an embodiment of the present invention, the reliability of each connectivity-node and the source node(s) is computed individually based on one or more reliability-parameters using data analytics and machine learning. In an embodiment of the present invention, the one or more reliability parameters include, but are not limited to, age, maintenance schedule, weather conditions, historical outage data, and individual real-time condition-variables. In an exemplary embodiment of the present invention, the individual real-time condition-variables may include, but are not limited to, node location, load profile, oil or winding temperature, dissolve gas analysis result for one or more nodes (in particular for transformers) and transformer noise. In operation, the computation unit 126 is configured to receive the age, maintenance schedule, weather conditions and historical outage data associated with each of the connectivity-node from the data acquisition unit 124 and/or the network-database 124a. Further, the computation unit is configured to compute reliability of connectivity-node individually based on at least one of: age, maintenance schedule, weather conditions, historical outage data, and individual real-time condition-variables using data analytics and machine learning. In an embodiment of the present invention, the one or more reliability parameters may be selected by a user via the interface unit 122.

In accordance with various embodiments of the present invention, the computation unit 126 is configured to compute network reliability up to the selected end-node based on the evaluated switched ON source node(s) available for power supply, reliability of each connectivity-node downstream of said evaluated switched ON source node(s) facilitating power supply up to the selected end-node, and determined network topology from each switched ON source node(s) up to the selected end-node.

In accordance with various embodiments of the present invention, the network reliability is computed using one or more predefined set of rules. In an embodiment of the present invention, the one or more predefined set of rules are selected based on the determined network topology and switched ON source node(s) available for power supply. In operation, the computing unit 126 selects the predefined set of rules based on number of switched ON source node(s) available for power supply to individual line-sections connecting each connectivity-node with the neighboring connectivity-node(s), selected end-node and corresponding source node(s).

In an embodiment of the present invention, the one or more predefined set of rules comprises computing reliability of any line-section in relation with a single switched ON source node as a function of individual reliability of each node preceding the line-section. In particular, the reliability of a line-section in relation with a single switched ON source node is a product of individual reliability of each node preceding the line-section. In an alternate embodiment of the present invention, the predefined set of rules comprises computing reliability of a line-section in relation with the single source node as a function of reliability of a node preceding said line-section and reliability of a line section prior to the node preceding said line-section.

In an embodiment of the present invention, the one or more predefined set of rules further comprises computing reliability of a line-section in relation with two or more switched ON source nodes available for power supply as a function of sub-section reliability from each of the two or more switched ON source nodes up to that line-section. In particular, the reliability of a line-section connected with two or more switched ON source nodes available for power supply is a product of probability of un-availability of respective sub-sections from respective switched ON source node(s) available for power supply up to said line-section subtracted from 1. Reliability of line-section connected with two or more switched ON source nodes=1-(probability of un-availability of respective sub-section from each of the source nodes available for power supply up to the line-section)

The probability of un-availability of a sub-section from a source node available for power supply up to the line-section connected with the two or more switched ON source-nodes is computed as the reliability of the sub-section from the source node available for power supply up to the line-section connected with the two or more switched ON source-nodes subtracted from 1.

As already described above in the specification, network reliability is a measure of probability with which the network will be available for power supply without downtime. Thereby, the probability of un-availability of a sub-section from a source node available for power supply up to the line-section=1−reliability of the sub-section from the source node available for power supply up to the line-section. The reliability of the sub-section from the source node available for power supply up to the line-section is the product of individual reliability of each of the nodes preceding said line-section.

Therefore, reliability of a line-section connected with two or more switched ON source nodes=1−(1−reliability of the sub-section from the first source node available for power supply up to the line-section) (1−reliability of the sub-section from the second source node available for power supply up to the line-section) . . . (1−reliability of the sub-section from the n source node available for power supply up to the line-section).

In an embodiment of the present invention, the one or more predefined set of rules further comprises computing reliability of a line-section marking end of a loop in the electrical network as a function of reliability of a line-section preceding the loop and cumulative reliability of each loop-section from said line-section preceding the loop up to the line-section marking end of the loop. In an embodiment of the present invention, the cumulative reliability of each loop-section from the line-section preceding the loop up to the line-section marking end of the loop is probability of un-availability of both loop-sections subtracted from 1.

In accordance with various embodiments of the present invention, the network reliability up to the selected end-node is the reliability of line-section connected directly with the end-node. The reliability of line-section connected directly to the end-node is computed based on at least one of: individual reliability of a node preceding the line-section connected directly to the end-node and reliability of a line-section prior to the node preceding the line-section connected directly to the end-node. The node is a switched ON source node or a connectivity-node downstream of the evaluated switched ON source node(s). In particular, the reliability of line-section connected directly to the end-node is a product of individual reliability of the node preceding the line-section connected directly to the end-node (if any) and the reliability of line-section prior to the node preceding the line-section connected directly to the end-node.

In an embodiment of the present invention, in case of a linear topology with a single source node as shown in FIG. 1B, the reliability of any line-section is a function of individual reliability of each preceding node. In an embodiment of the present invention, the reliability of a line-section is a product of individual reliability of each preceding node. In an alternate embodiment of the present invention, the reliability of any line-section in a network having a linear topology with a single source node is a function of individual reliability of the preceding node and the line section prior to the preceding node. In an embodiment of the present invention, the reliability of a line-section is a product of individual reliability of the preceding node and the line section prior to the preceding node. For example, with reference to FIG. 1B, network reliability up to the selected end-node is the reliability of line-section 4 supplying power to the end-node. If the individual reliability of nodes S1, A, B, and C is R1, R2, R3, and R4 respectively, then the reliability of line-section 1 is R1, reliability of line-section 2 is R1×R2, reliability of line-section 3 is R1×R2×R3 and reliability of line-section 4 supplying power to the end-node is R1×R2×R3×R4. In an alternate embodiment of the present invention, if the individual reliability of nodes S1, A, B, and C is R1, R2, R3, and R4 respectively, then the reliability of line-section 1 is R1, reliability of line-section 2 is R1 (here R1 is also the reliability of line-section 1)×R2, reliability of line-section 3 is R1×R2 (i.e. reliability of line-section 2)×R3 and reliability of line-section 4 supplying power to the end-node is R1×R2×R3 (i.e. reliability of line-section 3)×R4. In another example with reference to FIG. 1B, if the probability of availability of nodes for power supply i.e. the individual reliability of nodes S1, A, B, and C is 0.6, 0.7, 0.8 and 0.9 respectively, then the reliability of line-section 1 is 0.6, reliability of line-section 2 is 0.6×0.7=0.42, reliability of line-section 3 is 0.6×0.7×0.8=0.33 and reliability of line-section 4 supplying power to the end-node is 0.6×0.7×0.8×0.9=0.30. From the afore-described example it may be understood that as the number of connectivity-nodes downstream of the switched ON source node(s) available for power supply increases in a linear topology with single source node, the network reliability up to the selected end-node decreases.

In an embodiment of the present invention, in case of a linear topology with a double source as shown in FIG. 1C, the reliability of any line-section is a function of sub-section reliability from each of the source nodes available for power supply up to the line-section. In particular, the reliability of any line-section is a product of probability of un-availability of each sub-section from each of the source nodes available for power supply up to the line-section subtracted from 1. For example, with reference to FIG. 1C, network reliability up to the selected end-node is the reliability of line-section between nodes B and C supplying power to the end-node. If the individual reliability of nodes S1, A, B, C and D is R1, R2, R3, R4 and R5 respectively, then the reliability of line-section between nodes B and C supplying power to the end-node is 1−(probability of un-availability of sub-section from S1 to the line section B-C) (probability of un-availability of sub-section from S2 to the line-section B-C) i.e. 1−(1−R1×R2×R3) (1−R3×R4).

Another example is described with reference to FIG. 1C′.

Let's consider that the probability of availability of nodes for power supply i.e. the individual reliability of nodes S1, A, B, and S2 is 0.6, 0.7, 0.8 and 0.9 respectively.

Reliability of sub-section from S1 to Line-section between nodes A and B (i.e. probability of availability of sub-section for power supply)=product of individual reliability of nodes S1 and A=0.6×0.7=0.42.

Probability of un-availability of sub-section from S1 to Line-section between nodes A and B for power supply=1−(probability of availability of sub-section for power supply) i.e. 1-0.42=0.58.

Reliability of sub-section from S2 to Line-section between nodes A and B (i.e. probability of availability of sub-section for power supply)=product of individual reliability of nodes S2 and B=0.80×0.90=0.72.

Probability of un-availability of sub-section from S2 to Line-section between nodes A and B for power supply=1−(probability of availability of sub-section for power supply) i.e. 1-0.72=0.28.

Probability of un-availability of each of the sub-sections from respective source nodes S1 and S2 up to the line-section between nodes A and B=(Probability of un-availability of sub-section from S1 to Line-section between nodes A and B for power supply)×(Probability of un-availability of sub-section from S2 to Line-section between nodes A and B for power supply)=0.58×0.28=0.16.

Probability of availability of each of the sub-sections from respective source nodes S1 and S2 up to the line-section between nodes A and B for power supply=1−(Probability of un-availability of each of the sub-sections from respective source nodes S1 and S2 up to the line-section between nodes A and B)=1-0.16=0.84.

The reliability of line-section between nodes A and B=Probability of availability of each of the sub-sections from respective source nodes S1 and S2 up to the line-section between nodes A and B for power supply. Therefore, the network reliability up to the selected end-node=0.84 (reliability of line-section connected directly with the end-node).

In an embodiment of the present invention, in case of a linear topology with double source and a branch off as shown in FIG. 1C, let the individual reliability of nodes S1, A, B, C, D and E be R1, R2, R3, R4, R5 and R6 respectively. The reliability of line-section between nodes B and C supplying power to the end-node is 1−(probability of un-availability of sub-section from S1 to the line section B-C) (probability of un-availability of sub-section from S2 to the line-section B-C) i.e. 1−(1−R1×R2×R3) (1−R3×R4).

The network reliability up to node E=Reliability of line-section connected directly with node E.

The reliability of line-section between node E and end-node=individual reliability of the preceding node (if any) and the reliability of line-section prior to the preceding node i.e. (individual reliability of node E)×reliability of line-section between nodes B and C=R5[1−(1−R1×R2×R3) (1−R3×R4)].

In an embodiment of the present invention, in case of a loop network topology with a single source node as shown in FIG. 1E, the network reliability up to the line-section marking the end of the loop (i.e. line-section 4) is a function of reliability of line-section preceding the loop (i.e. line-section 2) and cumulative reliability of each loop-section from line-section preceding the loop up to the line-section marking the end of loop. The cumulative reliability of each loop-section from line-section preceding the loop up to the line-section marking the end of loop=1−probability of un-availability of each of loop-sections. As the line-section marking the end of the loop is the line section connected directly with the end-node. Therefore, the network reliability up to the end-node is the network reliability up to the line-section marking the end of the loop. The network reliability up to the selected end-node is product of reliability of line-section preceding the loop (i.e. line-section 2) and the cumulative reliability of each loop-section from line-section preceding the loop up to the line-section marking the end of loop. In an example, let the individual reliability of nodes S1, A, B, C, and D be R1, R2, R3, R4, and R5 respectively.

Reliability of line-section preceding the loop (i.e. line-section 2)=R1×R2

The reliability of each loop-section from line-section preceding the loop up to the line-section marking the end of loop=1−probability of un-availability of each of loop-sections.

Probability of un-availability of loop-section from node B to line-section 4=1−(probability of availability of loop-section from node B to line-section 4) i.e. 1−(R3×R4).

Probability of un-availability of loop-section from node D to line-section 4=1−(probability of availability of loop-section from node D to line-section 4) i.e. 1−(R5).

Probability of un-availability of both loop-sections to line-section 4=(1−(R3×R4)) (1−R5).

The reliability of each loop-section from line-section preceding the loop up to line-section 4 (i.e. probability of availability of power supply from each loop-section up to line-section 4)=1−(1−(R3×R4)) (1−R5).

The network reliability up to the selected end-node is the product of reliability of line-section preceding the loop (i.e. line-section 2) and the reliability of each loop-section from line-section preceding the loop up to line-section 4=R1×R2[1−(1−(R3×R4)) (1−R5)]

In an embodiment of the present invention, the visualization unit 128 is configured to receive the network reliability up to the selected end node from the computation unit 126. Further, the visualization unit 128 is configured to visualize the network-connectivity model generated by the data acquisition unit 124. In an embodiment of the present invention, the visualization unit 128 is integrated with a QGIS tool. In operation, the visualization unit 128 is configured to visualize the network-connectivity model via GIS maps illustrating the electrical network 102 spreading over an area, further illustrating each sub-section of the electrical network, each node in the sub-section and its connection with neighboring node. In an embodiment of the present invention, the visualization unit 128 is configured to depict the network reliability up to selected end-node on the GIS map. In an embodiment of the present invention, the visualization unit 128 is configured to simulate the individual reliability of each node in the network, in particular the reliability of source nodes and connectivity-nodes as a notional flow through the line-sections. The visualization unit 128 is configured to depict the changing value of reliability in real-time as the notional quantity of reliability flows through the other nodes in the network, and finally reaches the selected end-node. In particular, the reliability of switched ON source node(s) and each connectivity-node downstream of the switched ON source node(s) up to the selected end-node is simulated in real-time as a notional flow through the line-sections connecting the switched ON source node(s), the end-node and said each connectivity-node downstream of the switched ON source node(s) up to the end-node. In an embodiment of the present invention, the visualization unit 128 is configured to generate at least one of: an alarm or a notification with colored lines on the map for transmission to the client-computing device 110 if the computed network reliability falls below a preset threshold.

Advantageously, the system of the present invention affords a technical effect in the realm of power transmission and distribution by facilitating efficient detection of power outages or faults in the electrical network in advance by way of network reliability. The system of the present invention, computes reliability of an electrical network up to any end-node in real time as well as for a future time duration. The system of the present invention computes network reliability before an actual outage, thereby facilitating network planning, reconfiguration or fixing of components to avoid the predicted outage, and solving the technical problem of electrical outages due to components or power line failure. Further, the system of the present invention, computes reliability based on multiple network-variables, such as, age, historical data, maintenance schedule, weather etc. thereby providing various choices to plan a network. Yet further, the system provides visuals of the entire network over an area with each node, line-sections and reliability, which further assists in precise network planning and configuring. Yet further, the system of the present invention affords accuracy in computation of network reliability, saves time and is economical. Yet further, the system of the present invention facilitates efficient utilization of power in the electrical network.

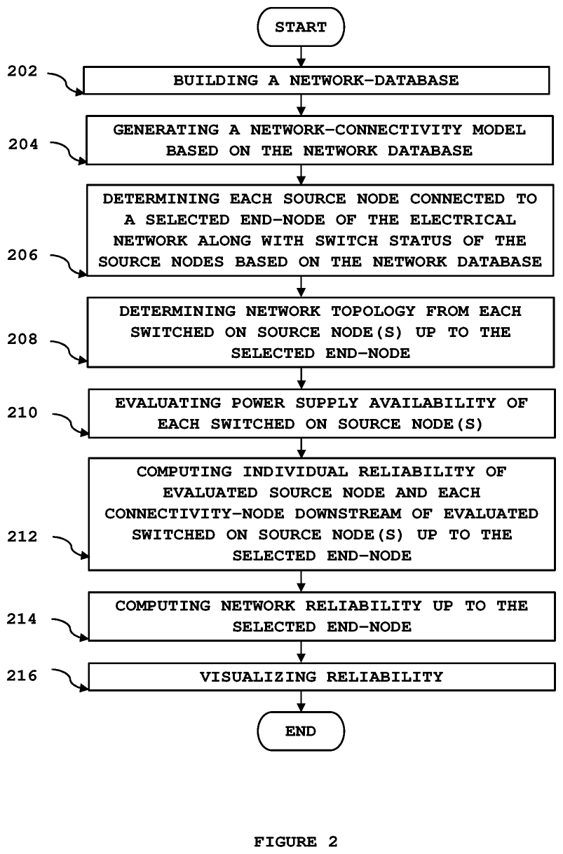

Referring to FIG. 2, a flowchart illustrating a method for evaluating reliability of an electrical network is shown, in accordance with various embodiments of the present invention.

At step 202, a network-database is built. In an embodiment of the present invention, information associated with each node of the selected electrical network including, but not limited to, power plants, Distributed Energy Resources (DERs), substations, transformers, transmission lines, circuit breakers, switches, distribution lines, and consumers along with their interconnection or topology is retrieved. In operation, in an embodiment of the present invention, switch status of each node of an electrical network (102 of FIG. 1) is retrieved. In an exemplary embodiment of the present invention, the switch status is retrieved from a SCADA system interfacing with the electrical network. In an embodiment of the present invention, real-time condition-variables of each node of the electrical network are retrieved via a sensor system (106 of FIG. 1). In an embodiment of the present invention, the real-time condition-variables include, but are not limited to, node location, load profile, faults, quality, weather conditions near each of the individual nodes, oil or winding temperature, dissolve gas analysis result for one or more nodes (in particular for transformers) and any other data associated with various nodes(components) of the electrical network. In an embodiment of the present invention, the weather forecast, consumer information associated with the electrical network, vegetation data, power flow data, and historical data associated with each node(component) of the electrical network is retrieved from external resources (108 of FIG. 1). In an exemplary embodiment of the present invention, the consumer information, includes, but is not limited to, customer name, location, load capacity, etc. The historical data includes node type, age, failure history, and maintenance history. The vegetation data includes data associated with trimming of tree and growth rate of trees near or around any of the node of the electrical network, which can adversely affect the network and/or network sub-section.

Further, a network-database is built based on the retrieved data using one or more data compression techniques. The network-database comprises information associated with each node of the electrical network. The network-database further comprises information related to circuit breakers and switches associated with each node, information associated with each sub-section and nodes of the network. In an embodiment of the present invention, the information associated with each node, herein after referred to as node information, includes, but is not limited to, location, type, function, switch status, load capacity, quality, age, fault history, maintenance schedule and vegetation data of each node, interconnection with neighbouring nodes, and line-section connecting the neighbouring nodes. In an embodiment of the present invention, the network-database is updated in real-time based on changes in the retrieved data.

At step 204, a network-connectivity model is generated based on the network-database. In an embodiment of the present invention, a network-connectivity model is generated based on the node information in the network-database using data processing and analytics. The network-connectivity model is representative of graphical representation of the electrical network spreading over an area, further illustrating each sub-section of the electrical network, each node in the sub-section and its connection with neighboring nodes via line-sections.

At step 206, each source node connected to a selected end-node of the electrical network along with switch status of the source nodes is determined based on the network-database. In an embodiment of the present invention, the source node is representative of any node of the electrical network from which power supply commences for transmission and/or distribution. In an exemplary embodiment of the present invention, the source node is a distribution substation and/or a distributed energy resource (DER). Further, the end-node is representative of any node of the electrical network, which is to receive power supply for consumption and/or further transmission or distribution. In an exemplary embodiment of the present invention, the end-node is a consumer. In an embodiment of the present invention, each source node connected to a selected end-node is identified and switch status of the identified source node(s) is determined based on node information associated with the electrical network retrieved from the network-database. In an embodiment of the present invention, each source node connected to the selected end-node and its switch status is determined using data analysis. In operation, the source node(s) having power flow towards the selected end-node via one or more power supply paths are representative of source node(s) connected to the selected end-node. In accordance with various embodiments of the present invention, the source node(s) may be connected directly with the selected end-node or indirectly with the selected end-node via other nodes there between. In an embodiment of the present invention, a source node with switch set to close position is indicative of switched ON source node, and a source node with switch set to open position is indicative of switched OFF source node. In an embodiment of the present invention, a DER source node with switch status closed and non-islanding is indicative of a switched ON DER source node. In an embodiment of the present invention, the power supply effect of DER is limited to the islanded section(s) only, considering DER source node can only power within corresponding islanding limits during an emergency.

At step 208, network topology from each switched ON source node(s) up to the selected end-node is determined. In an embodiment of the present invention, the network topology, also referred to as power supply topology, from each switched ON source node(s) up to the selected end-node is determined based on the node information stored in the network-database using data analysis. In an embodiment of the present invention, determining network topology from each of the switched ON source node(s) comprises determining each connectivity-node downstream of the switched ON source node(s) up to the selected end-node, and determining arrangement pattern and line-sections connecting the switched ON source node(s), the selected end-node and each connectivity-node with the neighboring connectivity-node(s), selected end-node and corresponding source node(s). In an embodiment of the present invention, the connectivity-node is any node of the electrical network which transmits/or distributes power from source node to the end-node. In an embodiment of the present invention, the line-sections may be transmission or distribution lines. In an exemplary embodiment of the present invention, the connectivity-nodes may include, but are not limited to, distribution components, and the line-sections may include, but are not limited to, distribution lines. In an embodiment of the present invention, the connectivity-node may be directly connected to the source node and/or end-node via the line-sections. Further, a connectivity-node may be indirectly connected to the source node and/or the end-node via the other connectivity-nodes there between via the line sections. In an embodiment of the present invention, each node, including the source node, the connectivity-node, and the end-node has three phases A, B and C. Further, each line-section has three phases A, B and C. In accordance with various embodiments of the present invention, a line section with phase A, B or C connects the same phase of one or more nodes on both ends. In accordance with various embodiments of the present invention, the network topology from the source node(s) up to the selected end-node can be at least one of: a straight line, a loop and a branch off.

At step 210, power supply availability of each switched ON source node(s) is evaluated. In an embodiment of the present invention, the power supply availability of each switched ON source node(s) is evaluated based on at least one of: the determined network topology and availability status of each connectivity-node downstream of the corresponding switched ON source node(s) up to the selected end-node. In an embodiment of the present invention, each connectivity-node with switch in closed position is considered as available connectivity-node. Each connectivity-node with switch in open position, or connectivity-node on hot standby, down due to fault or maintenance purposes is considered unavailable. In an embodiment of the present invention, the availability of each connectivity-node downstream of the corresponding switched ON source node(s) up to the selected end-node via a single power supply path is indicative that the switched ON source node(s) is available for power supply. Referring to FIG. 1B, a linear network topology is shown. As shown in FIG. 1B, a single source node S1 is connected to supply power to the end-node (EN) via the connectivity-nodes A, B and C through a linear path. If any of the connectivity-nodes before the end-node malfunctions or is switched OFF, then the power supply to end-node is disconnected, and the source node S1 is considered unavailable for power supply.

Referring to FIG. 1C, an example of linear topology with two source nodes supplying power to the end-node is illustrated. In case any one source node or any connectivity-node from one of the source nodes to the end-node fails, the other node will supply power to the end-node. Referring to FIG. 1D, a linear network topology with a branch off is illustrated. Referring to FIG. 1E, a loop network topology from a single source node is illustrated. Referring to FIG. 1F, a combination of loop and linear network topologies is illustrated. As shown in the figure, two sources S1 and S2 are powering the end-node.

Referring to FIG. 1G, a combination of loop and branch off network topology is illustrated. As shown in the figure there are two sources S1 and S2 supplying power to the end-node. Source node S1 is supplying power through two paths. First path comprises connectivity-nodes A, D and F, and the second path comprises connectivity-nodes A, B and F. In case connectivity-node A malfunctions, then power supply from source S1 stops, however if B malfunctions, power supply from S1 continues via A, D, and F. Similarly, if D malfunctions, then power supply from S1 continues from A, B and F. In case A and/or both B and D malfunctions, then power supply from source S2 continues, and S2 is considered available for power supply.

At step 212, the individual reliability of the evaluated switched ON source node(s) and each connectivity-node downstream of evaluated switched ON source node(s) up to the selected end-node is computed. In an embodiment of the present invention, individual reliability of connectivity-node(s) that are switched ON is computed. In an embodiment of the present invention, the reliability of each connectivity-node and the source node(s) are computed individually in real-time or a future time duration based on one or more reliability-parameters using data analytics and/or machine learning. In an embodiment of the present invention, the one or more reliability parameters include, but are not limited to, age, maintenance schedule, weather conditions, historical outage data, and individual real-time condition-variables associated with each connectivity-node and the source node(s). In an exemplary embodiment of the present invention, the individual real-time condition-variables may include, but are not limited to, node location, load profile, oil or winding temperature, dissolve gas analysis result for one or more nodes (in particular for transformers), and transformer noise. In operation, the age, maintenance schedule, weather conditions and historical outage data associated with each of the connectivity-node is received from the network-database and/or a sensor system (106 of FIG. 1). Further, the reliability of connectivity-node is computed individually based on at least one of: age, maintenance schedule, weather conditions, historical outage data, and individual real-time condition-variables using data analytics and/or machine learning. In an embodiment of the present invention, the one or more reliability parameters may be selected by a user.

At step 214, network reliability up to the selected end-node is computed. In an embodiment of the present invention, the network reliability up to the selected end-node is computed based on at least one of: the evaluated switched ON source node(s) available for power supply and its associated individual reliability, determined network topology from each switched ON source node(s) up to the selected end-node, and reliability of each connectivity-node downstream of said evaluated switched ON source node(s) facilitating power supply up to the selected end-node.

In accordance with various embodiments of the present invention, the network reliability is computed using one or more predefined set of rules. In an embodiment of the present invention, the one or more predefined set of rules are selected based on the determined network topology and evaluated switched ON source node(s) available for power supply. In operation, the predefined set of rules are selected based on number of switched ON source node(s) available for power supply to individual line-sections connecting the evaluated switched ON source node(s), the end-node and each of the connectivity-nodes downstream of the switched ON source node(s) up to the end-node.

In accordance with various embodiments of the present invention, the network reliability up to the selected end-node is the reliability of line-section connected directly with the end-node. The reliability of line-section connected directly to the end-node is computed based on at least one of: individual reliability of a node preceding the line-section connected directly to the end-node and reliability of a line-section prior to the node preceding the line-section connected directly to the end-node. The node is a switched ON source node or a connectivity-node downstream of the evaluated switched ON source node(s). In particular, the reliability of line-section connected directly to the end-node is a product of individual reliability of the node preceding the line-section connected directly to the end-node (if any) and the reliability of line-section prior to the node preceding the line-section connected directly to the end-node.

In an embodiment of the present invention, the one or more predefined set of rules comprises computing reliability of any line-section in relation with a single switched ON source node as a function of individual reliability of each node preceding the line-section. In particular, the reliability of a line-section in relation with a single switched ON source node is a product of individual reliability of each node preceding the line-section. In an alternate embodiment of the present invention, the predefined set of rules comprises computing reliability of a line-section in relation with the single source node as a function of reliability of a node preceding said line-section and reliability of a line section prior to the node preceding said line-section.

In an embodiment of the present invention, the one or more predefined set of rules further comprises computing reliability of a line-section in relation with two or more switched ON source nodes available for power supply as a function of sub-section reliability from each of the two or more switched ON source nodes up to that line-section. In particular, the reliability of a line-section connected with two or more switched ON source nodes available for power supply is a product of probability of un-availability of respective sub-sections from respective switched ON source node(s) available for power supply up to said line-section subtracted from 1. Reliability of line-section connected with two or more switched ON source nodes=1−(probability of un-availability of respective sub-section from each of the source nodes available for power supply up to the line-section)

The probability of un-availability of a sub-section from a source node available for power supply up to the line-section connected with the two or more switched ON source-nodes is computed as the reliability of the sub-section from the source node available for power supply up to the line-section connected with the two or more switched ON source-nodes subtracted from 1.

As already described above in the specification, network reliability is a measure of probability with which the network will be available for power supply without downtime. Thereby, the probability of un-availability of a sub-section from a source node available for power supply up to the line-section=1−(reliability of the sub-section from the source node available for power supply up to the line-section). The reliability of the sub-section from the source node available for power supply up to the line-section is the product of individual reliability of each of the nodes preceding said line-section.

Therefore, Reliability of a line-section connected with two or more switched ON source nodes=1−(1−reliability of the sub-section from the first source node available for power supply up to the line-section) (1−reliability of the sub-section from the second source node available for power supply up to the line-section) . . . (1−reliability of the sub-section from the n source node available for power supply up to the line-section).

In an embodiment of the present invention, the one or more predefined set of rules further comprises computing reliability of a line-section marking end of a loop in the electrical network as a function of reliability of a line-section preceding the loop and cumulative reliability of each loop-section from said line-section preceding the loop up to the line-section marking end of the loop. In an embodiment of the present invention, the cumulative reliability of each loop-section from the line-section preceding the loop up to the line-section marking end of the loop is probability of un-availability of both loop-sections subtracted from 1.

In an embodiment of the present invention, in case of a linear topology with a single source node, the reliability of any line-section is a function of individual reliability of each preceding node. In an embodiment of the present invention, the reliability of a line-section is a product of individual reliability of each preceding node. In an alternate embodiment of the present invention, the reliability of any line-section in a network having a linear topology with a single source node is a function of individual reliability of the preceding node and the line section prior to the preceding node. In an embodiment of the present invention, the reliability of a line-section is a product of individual reliability of the preceding node and the line section prior to the preceding node. For example, with reference to FIG. 1B, if the individual reliability of nodes S1, A, B, and C is R1, R2, R3, and R4 respectively, then the reliability of line-section 1 is R1, reliability of line-section 2 is R1×R2, reliability of line-section 3 is R1×R2×R3 and reliability of line-section 4 supplying power to the end-node is R1×R2×R3×R4. The reliability of line-section 4 is representative of network reliability up to the selected end-node. In an alternate embodiment of the present invention, if the individual reliability of nodes S1, A, B, and C is R1, R2, R3, and R4 respectively, then the reliability of line-section 1 is R1, reliability of line-section 2 is R2×R1 (here R1 is also the reliability of line-section 1), reliability of line-section 3 is R1×R2 (i.e. reliability of line-section 2)×R3 and reliability of line-section 4 supplying power to the end-node is R1×R2×R3 (i.e. reliability of line-section 3)×R4. In another example with reference to FIG. 1B, if the probability of availability of nodes for power supply i.e. the individual reliability of nodes S1, A, B, and C is 0.6, 0.7, 0.8 and 0.9 respectively, then the reliability of line-section 1 is 0.6, reliability of line-section 2 is 0.6×0.7=0.42, reliability of line-section 3 is 0.6×0.7×0.8=0.33 and reliability of line-section 4 supplying power to the end-node is 0.6×0.7×0.8×0.9=0.30. From the afore-described example it may be understood that as the number of connectivity-nodes downstream of the switched ON source node(s) available for power supply increases in a linear topology with single source node, the network reliability up to the selected end-node decreases.

In an embodiment of the present invention, in case of a linear topology with a double source as shown in FIG. 1C, the reliability of any line-section is a function of sub-section reliability from each of the source nodes available for power supply up to the line-section. In particular, the reliability of any line-section is a product of probability of un-availability of each network-section from each of the source nodes available for power supply up to the line-section subtracted from 1. For example, with reference to FIG. 1C, network reliability up to the selected end-node is the reliability of line-section between nodes B and C supplying power to the end-node. If the individual reliability of nodes S1, A, B, C and D is R1, R2, R3, R4 and R5 respectively, then the reliability of line-section between nodes B and C supplying power to the end-node is 1−(probability of un-availability of network-section from S1 to the line section B-C) (probability of un-availability of network-section from S2 to the line-section B-C) i.e. 1−(1−R1×R2×R3) (1−R3×R4).

Another example is described with reference to FIG. 1C′.

Let the probability of availability of nodes for power supply i.e. the individual reliability of nodes S1, A, B, and S2 is 0.6, 0.7, 0.8 and 0.9 respectively.

Reliability of sub-section from S1 to Line-section between nodes A and B (i.e. probability of availability of sub-section for power supply)=product of individual reliability of nodes S1 and A=0.6×0.7=0.42.

Probability of un-availability of sub-section from S1 to Line-section between nodes A and B for power supply=1−(probability of availability of sub-section for power supply) i.e. 1−0.42=0.58.

Reliability of sub-section from S2 to Line-section between nodes A and B (i.e. probability of availability of sub-section for power supply)=product of individual reliability of nodes S2 and B=0.80×0.90=0.72.

Probability of un-availability of sub-section from S2 to Line-section between nodes A and B for power supply=1−(probability of availability of sub-section for power supply) i.e. 1−0.72=0.28.

Probability of un-availability of each of the sub-sections from respective source nodes S1 and S2 up to the line-section between nodes A and B=(Probability of un-availability of sub-section from S1 to Line-section between nodes A and B for power supply)×(Probability of un-availability of sub-section from S2 to Line-section between nodes A and B for power supply)=0.58×0.28=0.16.

Probability of availability of each of the sub-sections from respective source nodes S1 and S2 up to the line-section between nodes A and B for power supply=1−(Probability of un-availability of each of the sub-sections from respective source nodes S1 and S2 up to the line-section between nodes A and B)=1−0.16=0.84.

The reliability of line-section between nodes A and B=Probability of availability of each of the sub-sections from respective source nodes S1 and S2 up to the line-section between nodes A and B for power supply. Therefore, the network reliability up to the selected end-node=0.84 (reliability of line-section connected directly with the end-node).

In an embodiment of the present invention, in case of a linear topology with double source and a branch off as shown in FIG. 1C, let the individual reliability of nodes S1, A, B, C, D and E be R1, R2, R3, R4, R5 and R6 respectively. The reliability of line-section between nodes B and C supplying power to the end-node is 1−(probability of un-availability of sub-section from S1 to the line section B-C) (probability of un-availability of sub-section from S2 to the line-section B-C) i.e. 1−(1−R1×R2×R3) (1−R3×R4).

The network reliability up to node E=Reliability of line-section connected directly with node E.

The reliability of line-section between node E and end-node=individual reliability of the preceding node (if any) and the reliability of line-section prior to the preceding node i.e. (individual reliability of node E)×reliability of line-section between nodes B and C=R5[1−(1−R1×R2×R3) (1−R3×R4)].

In an embodiment of the present invention, in case of a loop network topology with a single source node as shown in FIG. 1E, the network reliability up to the line-section marking the end of the loop (i.e. line-section 4) is a function of reliability of line-section preceding the loop (i.e. line-section 2) and cumulative reliability of each loop-section from line-section preceding the loop up to the line-section marking the end of loop. The cumulative reliability of each loop-section from line-section preceding the loop up to the line-section marking the end of loop=1−probability of un-availability of each of loop-sections. As the line-section marking the end of the loop is the line section connected directly with the end-node. Therefore, the network reliability up to the end-node is the network reliability up to the line-section marking the end of the loop. The network reliability up to the selected end-node is product of reliability of line-section preceding the loop (i.e. line-section 2) and the cumulative reliability of each loop-section from line-section preceding the loop up to the line-section marking the end of loop. In an example, let the individual reliability of nodes S1, A, B, C, and D be R1, R2, R3, R4, and R5 respectively.

Reliability of line-section preceding the loop (i.e. line-section 2)=R1×R2

The reliability of each loop-section from line-section preceding the loop up to the line-section marking the end of loop=1−probability of un-availability of each of loop-sections.

Probability of un-availability of loop-section from node B to line-section 4=1−(probability of availability of loop-section from node B to line-section 4) i.e. 1−(R3×R4).

Probability of un-availability of loop-section from node D to line-section 4=1−(probability of availability of loop-section from node D to line-section 4) i.e. 1−(R5).

Probability of un-availability of both loop-sections to line-section 4=(1−(R3×R4)) (1−R5).

The reliability of each loop-section from line-section preceding the loop up to line-section 4 (i.e. probability of availability of power supply from each loop-section up to line-section 4)=1−(1−(R3×R4)) (1−R5).

The network reliability up to the selected end-node is the product of reliability of line-section preceding the loop (i.e. line-section 2) and the reliability of each loop-section from line-section preceding the loop up to line-section 4=R1×R2[1−(1−(R3×R4)) (1−R5)]

At step 216, the network reliability up to the selected end-node is visualized. In an embodiment of the present invention, the network reliability up to selected end-node is illustrated on a GIS map. In particular, the reliability of switched ON source node(s) and each connectivity-node downstream of the switched ON source node(s) up to the selected end-node is simulated in real-time as a notional flow through the line-sections connecting the switched ON source node(s), the end-node and said each connectivity-node downstream of the switched ON source node(s) up to the end-node. In an embodiment of the present invention, at least one of: an alarm or a notification with colored lines is generated on the map for transmission to a client-computing device if the computed network reliability falls below a preset threshold.

Advantageously, the method of the present invention affords a technical effect in the realm of power transmission and distribution by facilitating efficient detection of power outages or faults in the electrical network in advance by way of network reliability. The method of the present invention, provides computation of reliability of an electrical network up to any end-node in real time as well as for a future time duration. The method of the present invention computes network reliability before an actual outage, thereby facilitating network planning, reconfiguration or fixing of components to avoid the predicted outage, and solving the technical problem of electrical outages due to components or power line failure. Further, the method of the present invention, computes reliability based on multiple network-variables, such as, age, historical data, maintenance schedule, weather etc. thereby providing various choices to plan a network. Yet further, the method of the present invention provides visuals of the entire network over an area with each node, line-sections and reliability, which further assists in precise network planning and configuring. Yet further, the method of the present invention affords accuracy to the processor for computation of network reliability, saves time and is economical. Yet further, the method of the present invention facilitates efficient utilization of power in the electrical network.

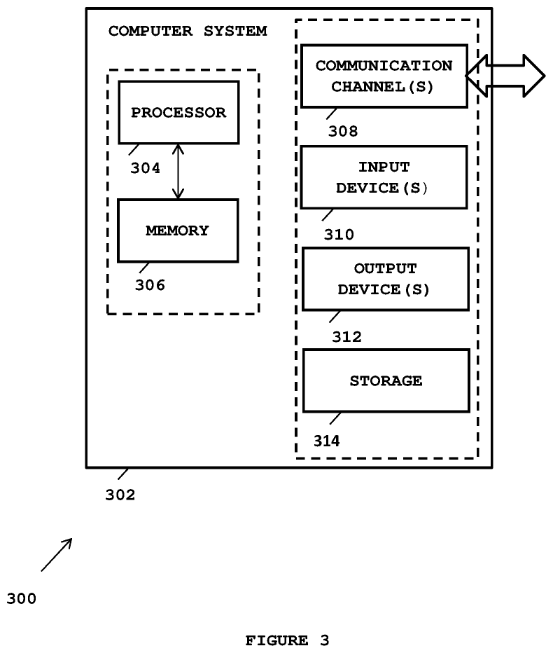

FIG. 3 illustrates an exemplary computer system in which various embodiments of the present invention may be implemented.

The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A method for evaluating network reliability up to an end-node in an electrical network, wherein the method is implemented by a processor executing program instructions stored in a memory, the method comprising:
determining, by the processor, each source node of the electrical network connected with the end-node and switch status of each of the determined source node(s) based on a node information associated with the electrical network using data analysis;
determining, by the processor, network topology from each switched ON source node(s) up to the end-node, wherein each connectivity-node downstream of the switched ON source node(s) up to the end-node, and arrangement pattern and line-sections connecting said switched ON source node(s), the end-node and said each connectivity-node downstream of the switched ON source node(s) up to the end-node are determined;
evaluating, by the processor, power supply availability of each switched ON source node(s) based on at least one of: the determined network topology, and an availability status of said each connectivity-node downstream of the corresponding switched ON source node(s) up to the end-node; and
computing, by the processor, network reliability up to the end-node based on at least one of: the evaluated switched ON source node(s) available for power supply and reliability of said evaluated switched ON source node(s), determined network topology from each evaluated switched ON source node(s) up to the end-node, and reliability of each connectivity-node downstream of the evaluated switched ON source node(s) up to the end-node.

2. The method as claimed in claim 1, wherein the node information associated with the electrical network is received from a network-database, said node information comprises location, type, function, switch status, load capacity, quality, age, fault history, maintenance schedule and vegetation data of each node, interconnection with neighbouring nodes, and line-section connecting the neighbouring nodes.

3. The method as claimed in claim 1, wherein the method further comprises building a network-database comprising the node information and updating the network-database in real-time, wherein building and updating the network-database comprises:
retrieving a switch status of each node of the electrical network from a SCADA system interfacing with the electrical network;
retrieving a real-time condition-variables of each node of the electrical network via at least one of: a SCADA system and a sensor system interfacing with the electrical network, wherein the real-time condition-variables comprises at least the node location, load profile, faults, quality, weather conditions near each of the nodes, oil or winding temperature, and dissolve gas analysis result for one or more nodes;
retrieving weather forecast, a consumer information associated with the electrical network, a vegetation data, a power flow data, and a historical data associated with each node of the electrical network; and
building and updating the network-database based on the retrieved switch status, the real-time condition-variables, the consumer information, the vegetation data, the power flow data, and the historical data associated with each node of the electrical network, and the weather forecast using one or more data compression techniques.

4. The method as claimed in claim 3, wherein the consumer information comprises customer name, location, and load capacity; the historical data comprises node type, age, failure history, and maintenance history; and the vegetation data comprises data associated with trimming of tree and growth rate of trees near or around any of the nodes of the electrical network.

5. The method as claimed in claim 1, wherein a source node of the electrical network having power flow towards the end-node via one or more power supply paths is representative of the source node of the electrical network connected with the end-node, further, wherein the source node connected with the end-node having switch set to close position is indicative of a switched ON source node.

6. The method as claimed in claim 1, wherein a Distributed Energy Resource (DER) of the electrical network having power flow towards the selected end-node via one or more power supply paths is representative of the source node connected with the end-node, and the DER connected with the selected end-node with switch status closed and non-islanding is indicative of a switched ON DER source node.

7. The method as claimed in claim 1, wherein the network topology from each switched ON source node(s) up to the end-node is determined based on the node information using data analysis, wherein the determined network topology from the source node(s) up to the selected end-node is least one of: a straight line, a loop and a branch off.

8. The method as claimed in claim 1, wherein a connectivity-node with switch in closed position is indicative of an available connectivity-node, further wherein, the availability of said each connectivity-node downstream of the corresponding switched ON source node(s) up to the end-node via a single power supply path is indicative that the corresponding switched ON source node(s) is available for power supply.

9. The method as claimed in claim 1, wherein reliability of the evaluated switched ON source node(s) and each connectivity-node downstream of the evaluated switched ON source node(s) is computed based on one or more reliability-parameters selected from a group comprising age, maintenance schedule, weather conditions, historical outage data, and real-time condition variables of said evaluated switched ON source node(s) and said each connectivity-node.

10. The method as claimed in claim 9, wherein the reliability of the evaluated switched ON source node(s) and each connectivity-node downstream of the evaluated switched ON source node(s) is computed in real-time and for a future time duration based on the one or more reliability-parameters using at least one of: data analytics and machine learning.

11. The method as claimed in claim 1, wherein the network reliability up to the end-node is computed using one or more predefined set of rules, wherein the one or more predefined set of rules are selected based on the determined network topology and the evaluated switched ON source node(s) available for power supply.

12. The method as claimed in claim 1, wherein the network reliability up to the end-node is computed using one or more predefined set of rules, wherein the one or more predefined set of rules are selected based on a number of the evaluated switched ON source node(s) available for power supply to respective determined line-sections connecting said evaluated switched ON source node(s), the end-node and said each connectivity-node downstream of the switched ON source node(s) up to the end-node.

13. The method as claimed in claim 1, wherein reliability of a line-section connected directly to the end-node is the network reliability up to the end-node, wherein the reliability of the line-section connected directly to the end-node is computed based on at least one of: reliability of a node preceding the line-section connected directly to the end-node and reliability of a line-section prior to the node preceding the line-section connected directly to the end-node, further wherein the node is a switched ON source node or a connectivity-node downstream of the evaluated switched ON source node(s).

14. The method as claimed in claim 12, wherein the one or more predefined set of rules comprises:
computing reliability of a line-section in relation with a single switched ON source node as a function of reliability of each node preceding the line-section; or
computing reliability of the line-section in relation with the single source node as a function of reliability of a node preceding said line-section and reliability of a line section prior to the node preceding said line-section; and
computing reliability of a line-section in relation with two or more switched ON source nodes available for power supply as a function of sub-section reliability from each of the two or more switched ON source nodes up to that line-section.

15. The method as claimed in claim 12, wherein the one or more predefined set of rules comprises:
computing reliability of a line-section connected with a single switched ON source node as a product of reliability of each node preceding the line-section; or
computing reliability of the line-section connected with the single source node as a product of reliability of a node preceding said line-section and reliability of a line section prior to the node preceding said line-section; and
computing reliability of a line-section connected with two or more switched ON source nodes available for power supply as a product of probability of un-availability of respective sub-sections from respective switched ON source node(s) available for power supply up to said line-section subtracted from 1.

16. The method as claimed in claim 15, wherein a probability of un-availability of a sub-section from a switched ON source node out of the two or more switched ON source nodes up to the line-section connected with the two or more switched ON source-nodes is computed as reliability of the sub-section from said switched ON source node up to the line-section connected with the two or more switched ON source-nodes subtracted from 1, further wherein, the reliability of the sub-section from said switched ON source node is the product of reliability of each of the nodes preceding said line-section.

17. The method as claimed in claim 11, wherein the predefined set of rules comprises computing reliability of a line-section marking end of a loop in the electrical network as a function of reliability of a line-section preceding the loop and cumulative reliability of each loop-section from said line-section preceding the loop up to the line-section marking end of the loop, wherein the cumulative reliability of each loop-section from the line-section preceding the loop up to the line-section marking end of the loop is probability of un-availability of both loop-sections subtracted from 1.

18. A system for evaluating network reliability up to an end-node in an electrical network, the system comprising:
a memory storing program instructions; a processor configured to execute program instructions stored in the memory; and a reliability computation engine executed by the processor, and configured to:
determine each source node of the electrical network connected with the end-node and switch status of each of the determined source node(s) based on a node information associated with the electrical network using data analysis;
determine network topology from each switched ON source node(s) up to the end-node, wherein each connectivity-node downstream of the switched ON source node(s) up to the end-node, and arrangement pattern and line-sections connecting said switched ON source node(s), the end-node and said each connectivity-node downstream of the switched ON source node(s) up to the end-node are determined;
evaluate power supply availability of each switched ON source node(s) based on at least one of: the determined network topology, and an availability status of said each connectivity-node downstream of the corresponding switched ON source node(s) up to the end-node; and
compute network reliability up to the end-node based on at least one of: the evaluated switched ON source node(s) available for power supply and reliability of said evaluated switched ON source node(s), determined network topology from each evaluated switched ON source node(s) up to the end-node, and reliability of each connectivity-node downstream of the evaluated switched ON source node(s) up to the end-node.

19. The system as claimed in claim 18, wherein the reliability computation engine comprises an interface unit executed by the processor, said interface unit configured to provide interfacing with a SCADA system, a sensor system, external resources, and a client-computing device, said interface unit configured to:
retrieve a switch status of each node of the electrical network from the SCADA system;
retrieve a real-time condition-variables of each node of the electrical network via at least one of: the SCADA system and the sensor system, wherein the real-time condition-variables comprises at least the node location, load profile, faults, quality, weather conditions near each of the nodes, oil or winding temperature, and dissolve gas analysis result for one or more nodes; and
retrieve weather forecast, a consumer information associated with the electrical network, a vegetation data, a power flow data, and a historical data associated with each node of the electrical network from the external resources.

20. The system as claimed in claim 19, wherein the reliability computation engine comprises a data acquisition unit executed by the processor, said data acquisition unit configured to build and update a network-database comprising the node information based on the retrieved switch status, the real-time condition-variables, the consumer information, the vegetation data, the power flow data, and the historical data associated with each node of the electrical network, and the weather forecast using one or more data compression techniques.

21. The system as claimed in claim 18, wherein the node information associated with the electrical network is received from a network-database, said node information comprises location, type, function, switch status, load capacity, quality, age, fault history, maintenance schedule and vegetation data of each node, interconnection with neighbouring nodes, and line-section connecting the neighbouring nodes.

22. The system as claimed in claim 18, wherein a source node of the electrical network having power flow towards the end-node via one or more power supply paths is representative of the source node of the electrical network connected with the end-node, further, wherein the source node connected with the end-node having switch set to close position is indicative of a switched ON source node.

23. The system as claimed in claim 18, wherein a Distributed Energy Resource (DER) of the electrical network having power flow towards the selected end-node via one or more power supply paths is representative of the source node connected with the end-node, and the DER connected with the selected end-node with switch status closed and non-islanding is indicative of a switched ON DER source node.

24. The system as claimed in claim 18, wherein the network topology from each switched ON source node(s) up to the end-node is determined based on the node information using data analysis, wherein the determined network topology from the source node(s) up to the selected end-node is least one of: a straight line, a loop and a branch off.

25. The system as claimed in claim 18, wherein a connectivity-node with switch in closed position is indicative of an available connectivity-node, further wherein, the availability of said each connectivity-node downstream of the corresponding switched ON source node(s) up to the end-node via a single power supply path is indicative that the corresponding switched ON source node(s) is available for power supply.

26. The system as claimed in claim 18, wherein reliability of the evaluated switched ON source node(s) and each connectivity-node downstream of the evaluated switched ON source node(s) is computed in real-time and for a future time duration based on one or more reliability-parameters using at least one of: data analytics and machine learning, wherein the one or more reliability parameters comprises age, maintenance schedule, weather conditions, historical outage data, and real-time condition variables of said evaluated switched ON source node(s) and said each connectivity-node.

27. The system as claimed in claim 18, wherein the network reliability up to the end-node is computed in real-time and for a future time duration using one or more predefined set of rules, wherein the one or more predefined set of rules are selected based on the determined network topology and the evaluated switched ON source node(s) available for power supply.

28. The system as claimed in claim 18, wherein the network reliability up to the end-node is computed using one or more predefined set of rules, wherein the one or more predefined set of rules are selected based on a number of the evaluated switched ON source node(s) available for power supply to respective determined line-sections connecting said evaluated switched ON source node(s), the end-node and said each connectivity-node downstream of the switched ON source node(s) up to the end-node.

29. The system as claimed in claim 18, wherein reliability of a line-section connected directly to the end-node is the network reliability up to the end-node, wherein the reliability of the line-section connected directly to the end-node is computed based on at least one of: reliability of a node preceding the line-section connected directly to the end-node and reliability of a line-section prior to the node preceding the line-section connected directly to the end-node, further wherein the node is a switched ON source node or a connectivity-node downstream of the evaluated switched ON source node(s).

30. The system as claimed in claim 28, wherein the one or more predefined set of rules comprises:
computing reliability of a line-section connected with a single switched ON source node as a product of reliability of each node preceding the line-section; or
computing reliability of the line-section connected with the single source node as a product of reliability of a node preceding said line-section and reliability of a line section prior to the node preceding said line-section; and
computing reliability of a line-section connected with two or more switched ON source nodes available for power supply as a product of probability of un-availability of respective sub-sections from respective switched ON source node(s) available for power supply up to said line-section subtracted from 1.

31. The system as claimed in claim 30, wherein a probability of un-availability of a sub-section from a switched ON source node out of the two or more switched ON source nodes up to the line-section connected with the two or more switched ON source-nodes is computed as reliability of the sub-section from said switched ON source node up to the line-section connected with the two or more switched ON source-nodes subtracted from 1, further wherein, the reliability of the sub-section from said switched ON source node is the product of reliability of each of the nodes preceding said line-section.

32. The system as claimed in claim 27, wherein the predefined set of rules comprises computing reliability of a line-section marking end of a loop in the electrical network as a function of reliability of a line-section preceding the loop and cumulative reliability of each loop-section from said line-section preceding the loop up to the line-section marking end of the loop, wherein the cumulative reliability of each loop-section from the line-section preceding the loop up to the line-section marking end of the loop is probability of un-availability of both loop-sections subtracted from 1.

33. The system as claimed in claim 18, wherein the system is configured to:
generate a network-connectivity model based on the node information using data processing and analytics, wherein the network-connectivity model is representative of a graphical representation of the electrical network spreading over an area with each sub-section of the electrical network, each node in the sub-section and connection of each said node with neighboring nodes via line-sections;
visualize network reliability up to the end-node on a map on a client-computing device based on the network-connectivity model in real-time, wherein the reliability of switched ON source node(s) and said each connectivity-node downstream of the switched ON source node(s) up to the end-node is simulated as a notional flow through the line-sections connecting said switched ON source node(s), the end-node and said each connectivity-node downstream of the switched ON source node(s) up to the end-node; and
generate at least one of: an alarm and a notification with colored lines on the map if the computed network reliability falls below a preset threshold.

34. A computer program product comprising:
a non-transitory computer-readable medium having computer-readable program code stored thereon, the computer-readable program code comprising instructions that, when executed by a processor, cause the processor to:
determine each source node of the electrical network connected with the end-node and switch status of each of the determined source node(s) based on a node information associated with the electrical network using data analysis;
determine network topology from each switched ON source node(s) up to the end-node, wherein each connectivity-node downstream of the switched ON source node(s) up to the end-node, and arrangement pattern and line-sections connecting said switched ON source node(s), the end-node and said each connectivity-node downstream of the switched ON source node(s) up to the end-node are determined;
evaluate power supply availability of each switched ON source node(s) based on at least one of: the determined network topology, and an availability status of said each connectivity-node downstream of the corresponding switched ON source node(s) up to the end-node; and
compute network reliability up to the end-node based on at least one of: the evaluated switched ON source node(s) available for power supply and reliability of said evaluated switched ON source node(s), determined network topology from each evaluated switched ON source node(s) up to the end-node, and reliability of each connectivity-node downstream of the evaluated switched ON source node(s) up to the end-node.
